(19) United States
(12) Patent Application Publication
(10) Pub. No.: US 2003/0106572 A1
(43) Pub. Date: Jun. 12, 2003

(54) System and method for ozonated water cleaning

(76) Inventors: Hirohiko Nishiki, Tenri-shi (JP); James M. Atkinson, Camas, WA (US); John Hartzell, Camas, WA (US)

Correspondence Address: David C. Ripma, Patent Counsel, Sharp Laboratories of America, Inc., 5750 NW Pacific Rim Boulevard, Camas, WA, 98607, US

(21) Appl. No.: 10/020,822

(22) Filed: Dec. 12, 2001

(51) Int. Cl. B08B 3/08

(52) U.S. Cl. 134/26; 134/61

(57) ABSTRACT

A system and method have been provided for cleaning integrated circuit and liquid crystal display substrates of organic residue, such as photoresist, using a high concentrate ozonated water. Chilled water is used to increase the ozone concentration in the water to approximately 90 parts per million. The cleaning method is especially effective when used subsequent to an organic stripping process. The etching rates of the combined process are effective, and the use of the high concentrate ozonated water after the organic stripper also removes any contaminants on the substrate accumulated as a result of using the organic stripper.

### BACKGROUND OF THE INVENTION

1. Field of the Invention

This invention generally relates to liquid crystal display (LCD) and integrated circuit (IC) fabrication and, more particularly, a system and method for using ozone as a cleaner of IC and LCD surfaces during their respective fabrication processes.

2. Description of the Related Art

An LCD panel is indispensable for notebook type personal computers (PCs) because it is light and thin, compared to a cathode ray tube (CRT) monitor. The price of LCD monitors have become cheaper over the years, but are still more expensive than the CRT monitors. Hence, further cost reduction is required before the LCD can replace the CRT. One method of reducing LCD costs is to improve production yields.

An organic stripper is commonly used for thin film transistor (TFT) LCD manufacturing. Organic strippers can remove photoresist and severe contamination effectively. However, it is common for organic residue to remain undissolved in the stripper. The organic residue in the stripper, in turn, contaminates the substrates to be subsequently cleaned. This contamination sometimes can lead to a decrease in production yields, especially in batch type processes, where the stripper is reused to clean up the substrates.

In general, the causes of organic contamination can be identified as follows:

1) native contamination from the ambient environment;

2) severe contamination, from photoresist and skin oil; and,

3) organic residue in the stripper.

As noted in U.S. Pat. No. 5,464,480 (Matthews), in the fabrication of semiconductor wafers, several process steps require contacting the wafers with fluids. Examples of such process steps include etching, photoresist stripping, and prediffusion cleaning. Often the chemicals utilized in these steps are quite hazardous in that they may comprise strong acids, alkalis, or volatile solvents. The equipment conventionally used for contacting semiconductor wafers with process fluid consists of a series of tanks or sinks into which cassette loads of semiconductor wafers are dipped. Such conventional wet processing equipment poses several difficulties.

First, moving the wafers from tank to tank may result in contamination that is extremely detrimental to the microscopic circuits created in the fabrication process. Second, the hazardous chemicals and deionized water which are used have to be regularly replaced with new solutions, usually introduced to the tank by bottle pour, chemical distribution, or from building facilities in the case of deionized water. The chemicals generally are manufactured by chemical companies and shipped to the semiconductor manufacturing plant. The chemical purity is thus limited by the quality of the water used by the chemical manufacturers, and by the container used for shipping and storing the chemical and by the handling of the chemical.

Moreover, as chemicals age, they can become contaminated with impurities from the air and from the wafers. The treatment of the last batch of wafers prior to fluid rejuvenation may not be as effective as treatment of the first batch of wafers in a new solution. Non-uniform treatment is a major concern in semiconductor manufacturing.

Some of the fluid contact steps of semiconductor manufacture include the removal of organic materials and impurities from the wafer surface. For example, in the manufacture of integrated circuits, it is customary to bake a photoresist coating onto a silicon wafer as part of the manufacturing process. This coating of photoresist or organic material must be removed after processing.

Generally, a wet photoresist strip process is performed by a solution of sulfuric acid spiked with an oxidizer of either hydrogen peroxide or ozone. However, there are many disadvantages to using a solution of sulfuric acid and an oxidizer to strip photoresist from wafers during semiconductor manufacture. First, the by-product of the resist strip reaction when hydrogen peroxide is used as the oxidizer is water, which dilutes the concentration of the bath and thereby reduces its ability to strip photoresist. Second, this process operates at a high temperature, generally between 80 degrees C. and 150 degrees C., typically above about 130 degrees C., which mandates the use of special heat resistant materials and components in order to house, circulate, and filter the solution, as well as requires extra energy to conduct the cleaning process. Third, the solution is hazardous to handle and dispose of and expensive to manufacture, transport and store.

Moreover, due to the build-up of impurities both dissolved and undissolved in the process bath, the solution must be changed periodically. Typically, the interval for chemical change out is about every eight hours. Because the chemical adversely affects the drain plumbing, the solution must be cooled to less than about 90 degrees C. prior to disposal. Thus, use of this photoresist stripping process requires either the use of additional tanks to contain the hot solution or the shut down of the process station during the chemical change period, reducing wafer throughput and increasing cost of ownership.

Finally, after use of a sulfuric acid solution for removal of photoresist, the wafers must be rinsed in hot deionized water since sulfate residues may crystallize on the wafer during processing causing process defects.

Another process often utilized for the removal of organic and metallic surface contaminants is the “RCA clean” process which uses a first solution of ammonium hydroxide, hydrogen peroxide, and water and a second solution of hydrochloric acid, hydrogen peroxide, and water. The RCA cleaning solutions typically are mixed in separate tanks. The wafers are first subjected to cleaning by the ammonium hydroxide solution, then are moved to a rinse tank, then to a tank containing the hydrochloric acid cleaning solution, and then to a final rinse tank. This process, like the sulfuric acid process, has the disadvantage of using strong chemicals. Moreover, the wafers are exposed to air during the transfers from tank to tank, allowing for contamination. Finally, the use of peroxide may cause the wafers to suffer aluminum contamination from the deposition of aluminum in the high pH ammonium hydroxide solution which is not totally removed in the hydrochloric solution.

U.S. Pat. No. 5,082,518 (Molinaro), describes a different approach to improving the sulfuric acid and oxidizer process of cleaning semiconductor wafers. The system in this patent provides a gas distribution system that includes a sparger plate with diffusion holes for distributing gas throughout the bath in the tank. The Molinaro patent provides an apparatus that distributes ozone directly into the treatment tank containing sulfuric acid. It has been found, however, that this diffusion system suffers several disadvantages.

First, the efficiency of ozone distribution and absorption into the water is lessened by the large bubbles of ozone produced by the apparatus. The amount of ozone absorbed is important to its ability to react with the sulfuric acid to remove organic materials from the wafers. Moreover, the type of diffusing element described in the Molinaro patent is believed to not uniformly distribute ozone throughout the tank. Finally, as with previous attempts to improve cleaning processes for wafers, hazardous chemicals are required, creating handling and disposal problems.

Other approaches use ozone-injected ultrapure water to clean organic impurities from silicon wafers at room temperature. However, this process also suffers several disadvantages. The process was intended for, and works on organic contamination layers of less than 50 Angstroms (Å). It is too slow to work on organic contamination layers of 50-250 mils.

Ozonated water has been shown to decompose organic materials. Therefore, ozonated water can be used to decompose the native contamination and the organic residue, which come from the organic stripper. However, ozone decomposition rates are relatively slow compared to organic solvents, and ozonated water cleaning has not been proven to an efficient method to remove severe contamination. Thus, even though the organic stripper residue contaminates the substrates to be cleaned, no convention process exists for replacing organic stripping with ozonated water cleaning.

It would be advantageous if a stripping and cleaning could be developed to minimize or eliminate the need for organic strippers.

It would be advantageous if a process could be developed for using ozonated water to clean substrate surfaces.

It would be advantageous if an IC cleaning process could be developed with the speed and effectiveness of an organic stripper, without contamination.

It would be advantageous if a speedy and effective ozonated water cleaning process could be developed.

### SUMMARY OF THE INVENTION

Accordingly, a method has been provided for cleaning IC or LCD surfaces. The method comprises: cleaning a substrate surface with an organic stripper; and, following the organic stripper cleaning, cleaning the substrate surface with ozonated water having an ozone concentration of 90 parts per million (PPM), or greater. Further, the cleaning of the substrate surface with ozonated water includes cleaning the substrate surface with ozonated water having a water temperature in the range of 5 to 10 degrees C., for a period of approximately 30 seconds.

The method further comprises: following the cleaning of the substrate surface with ozonated water, rinsing the substrate surface in deionized (DI) water.

Additional details of the above-described water ozone cleaning method and a system for cleaning water with high concentrate ozonated water are presented below.

### BRIEF DESCRIPTION OF THE DRAWING

FIG. 1 is a schematic block diagram of a convention strip and clean system (prior art).

FIG. 2 is a schematic block diagram illustrating the present invention system for cleaning substrate surface surfaces.

FIG. 3 is a graph illustrating the effectiveness of the present invention high concentrate ozone water process, compared to conventional organic stripping.

FIG. 4 is a graph illustrating the effect of cleaning a substrate with high concentrate ozone water, in comparison to DI water.

FIG. 5 is a flowchart illustrating a method for cleaning substrate surfaces in an IC or LCD fabrication process.

FIG. 6 is an alternate method for cleaning substrate surfaces in an LCD or IC fabrication process.

### DETAILED DESCRIPTION OF THE PREFERRED EMBODIMENTS

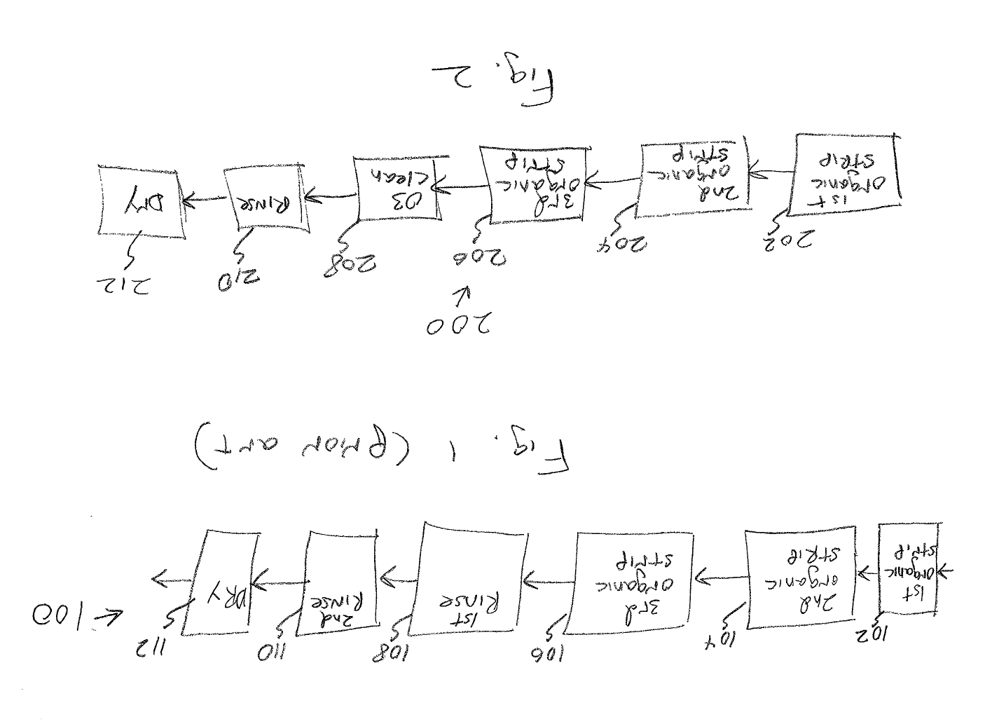

FIG. 1 is a schematic block diagram of a convention strip and clean system (prior art). Organic residue such as photoresist is typically cleaned with this process. The system 100 accepts a substrate to be cleaned at the input of the first organic strip unit 102. Cleaning of the substrate also occurs as it passes on to the second organic strip unit 104, and to the third organic strip unit 106. Then, the substrate is given a rinse with deionized water (DI) water in the first rinse unit 108 and the second rinse unit 110. Following the rinses, the substrate is dried at drier unit 112 and passed on for further processing.

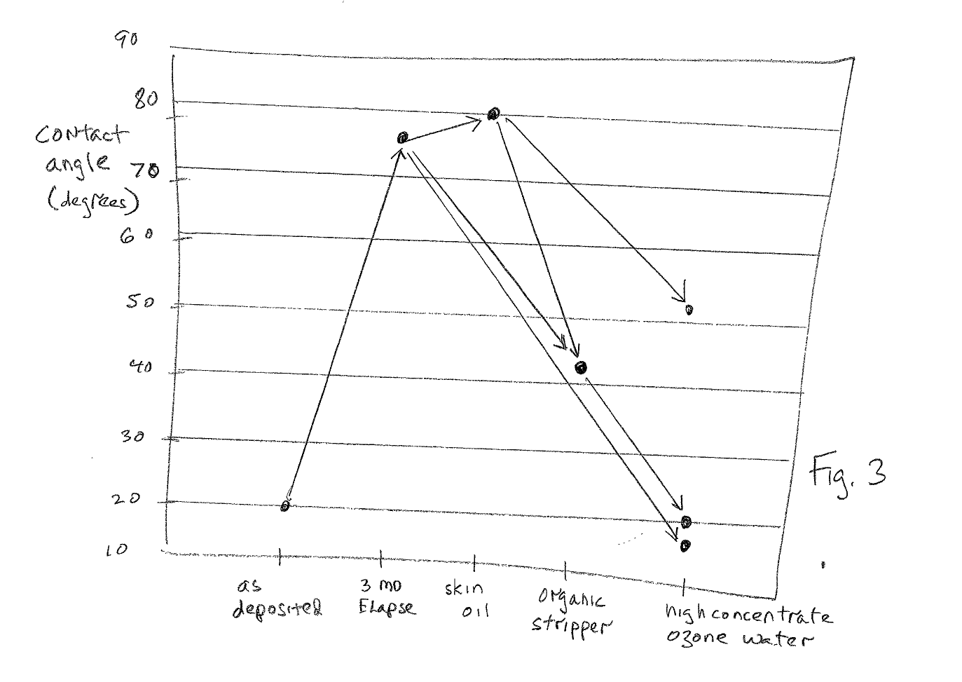

FIG. 2 is a schematic block diagram illustrating the present invention system for cleaning substrate surfaces. As used herein, substrate surfaces include surfaces that are processed in the fabrication of LCDs, and more generally in the fabrication of integrated circuits (ICs). The system 200 comprises at least one organic strip rinse unit. The figure actually depicts a first organic strip rinse unit 202, a second organic strip rinse unit 204, and a third organic strip rinse unit 206. The first organic strip rinse unit 202 has an input to accept a substrate surface, and an output to supply the substrate surface following a first rinse with an organic stripper. The second organic strip rinse unit 204 has an input connected to the output of first organic strip rinse unit 202, and an output to supply the substrate surface following a second rinse with an organic stripper. The third organic strip rinse unit 206 has an input connected to the output second organic strip rinse unit 206, and an output to supply the substrate surface following a third rinse with an organic stripper.

The system 200 also includes a high concentrate ozonated water rinse unit 208 having an input connected to the output of the third organic strip rinse unit 206. The high concentrate ozonated water rinse unit 208 has an output to supply the substrate surface following a rinse with ozonated water.

The present invention system is different from other ozone cleaning system in amount (concentration) of ozone that is delivered in the ozonated water. As a result, the etch rates are sufficiently high to remove relatively thick organic residue in a short amount of time. Specifically, the high concentrate ozonated water rinse unit 208 rinses the substrate surface with water having an ozone concentration of 90 parts per million (PPM), or greater. The high concentrate ozonated water rinse unit 208 rinses the substrate surface with ozonated water having a temperature in the range of 5 to 10 degrees C. Typically, the rinse time is approximately 30 seconds. The exact time is dependent on other variables in the process, such as the substrate thickness and the material to be cleaned.

The system 200 further comprises a deionized (DI) water rinse unit 210 having an input connected to the high concentrate ozonated water rinse unit output 208. The DI water rinse unit 210 has an output to supply the substrate surface following a rinse in deionized water. A dryer unit 212 has an input connected to the output of the DI water rinse unit 210. The drier unit 212 supplies the substrate surface at an output, following the drying of the substrate surface.

The present invention system can remove organic contamination at the same rates as the convention system of FIG. 1, using a high concentrate ozone water rinse process. In the ozone water rinse process, the substrates are cleaned by using the conventional organic stripper. Then, the stripper including the residue is rinsed out completely, not by Dl water, but by the ozone water. The organic residue from the stripper can be decomposed by the ozone water, so no organic contamination remains. The efficiency of cleaning by the ozonated water is dependent on the ozone concentration in the water, so the concentration has been made as high as possible. There are several known methods that can be used to increase ozone concentration. For example, the water can be chilled to be in the range of 5 to 10 degrees C., or ozone gas can be injected under pressure into the water. Alternately, the high ozone concentration is created by pressurizing ozone gas to dissolve in water.

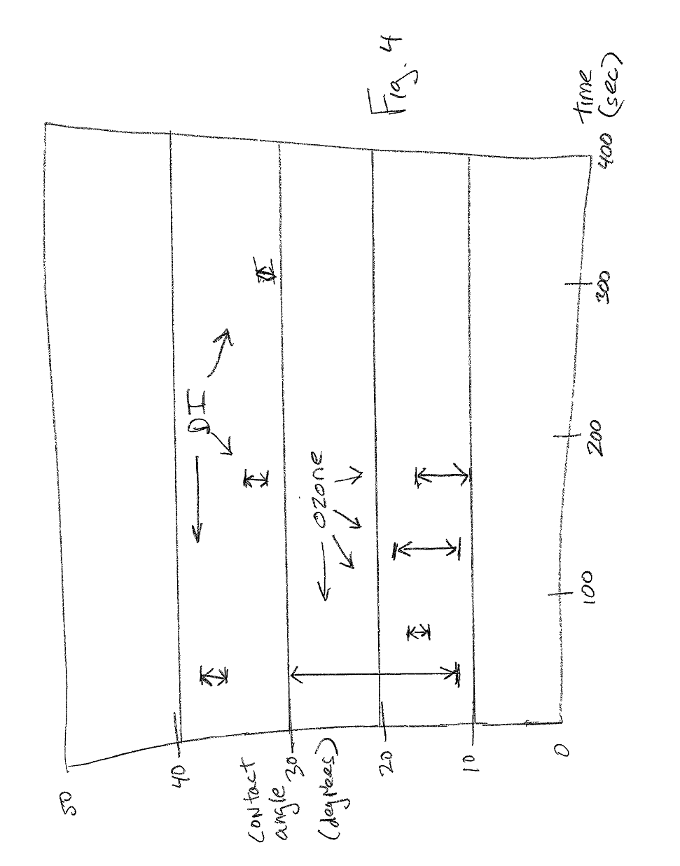

FIG. 3 is a graph illustrating the effectiveness of the present invention high concentrate ozone water process, compared to conventional organic stripping. The ozone water used in the experiment was chilled to 8° C. to increase the ozone concentration to 90 parts per million (PPM).

The cleanness of the substrate surface is evaluated by measuring the contact angle of the water drop. If the substrate is contaminated by organic materials, the surface become hydrophobic. The water beads up so that the contact angle increases. The substrate, as deposited, has a contact angle of 20 degrees. After three months in storage the angle has degraded to about 75 degree due to build up of contaminants on the substrate surface. If the substrate is touched by hand, the skin oil degrades the angle even further, to about 80 degrees. The organic stripper can clean the substrate to decrease the angle to around 40 degrees. However, the ozone water decreases the angle to less than 20 degrees, the as-deposited condition, unless the contamination is severe, such as skin oil. If the skin oil is cleaned in a two-step process, first with organic stripper and then with high concentrate ozone water, the contact angle can be reduced to the as deposited condition of 20 degrees. Thus, the combination of the organic cleaning and the ozone water rinsing is very effective.

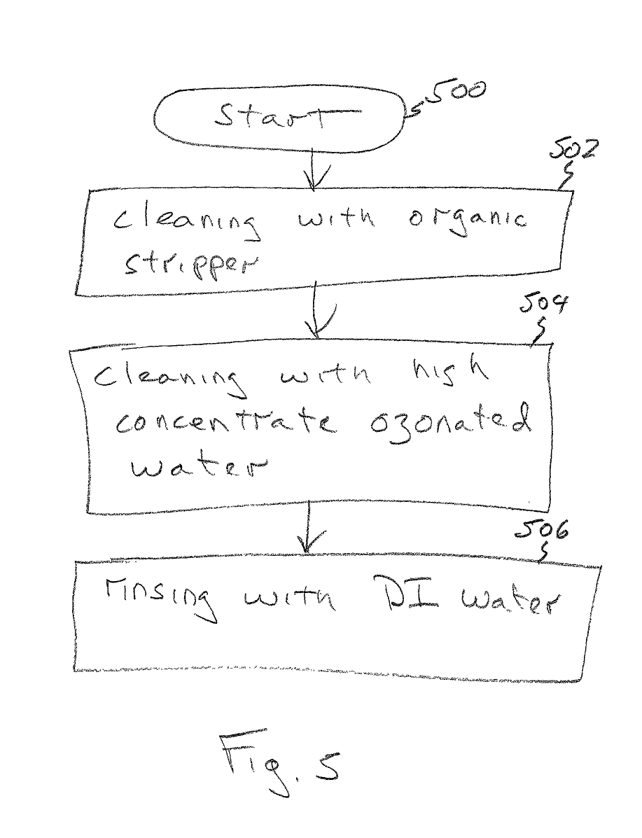

FIG. 4 is a graph illustrating the effect of cleaning a substrate with high concentrate ozone water, in comparison to DI water. The initial condition is that the substrates have been stripped in an organic stripper. The high concentrate ozone water is very effective with only a 30 second rinse, as the contact angle is in the range of 12 to 30 degrees. A rinse of 180 seconds only decreases the angle a few more degrees (in the range of 10 to 16 degrees). The Dl water rinse does not significantly decrease the angle. Thus, not only can the high concentrate ozone water rinse improve cleaning efficiency, it can also reduce the rinse process water usage and the process time.

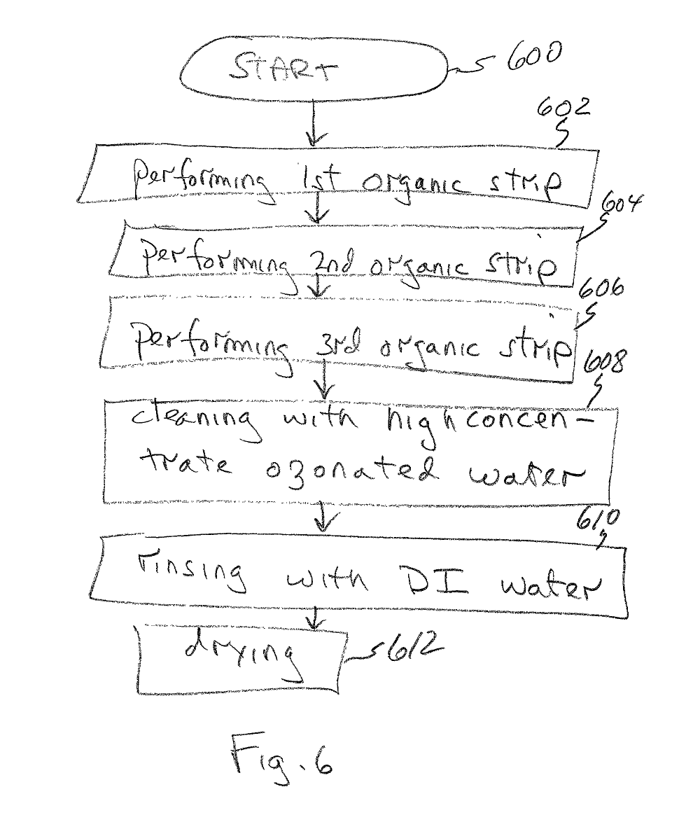

FIG. 5 is a flowchart illustrating a method for cleaning substrate surfaces in an IC or LCD fabrication process. Although the method, and the method described below by FIG. 6, is depicted as a sequence of numbered steps for clarity, no order should be inferred from the numbering unless explicitly stated. The method begins at Step 500. Step 502 cleans a substrate surface with an organic stripper. Step 504, following the organic stripper cleaning, cleans the substrate surface with high concentrate ozonated water. Cleaning the substrate surface with high concentrate ozonated water in Step 504 includes cleaning the substrate surface with water having an ozone concentration of 90 parts per million (PPM), or greater. Step 504 also includes cleaning the substrate surface with ozonated water having a water temperature in the range of 5 to 10 degrees C. Cleaning the substrate surface with high concentrate ozonated water includes cleaning the substrate surface in ozonated water for a period of approximately 30 seconds.

The method comprises a further step. Step 506, following the cleaning of the substrate surface with high concentrate ozonated water, rinses the substrate surface in deionized (DI) water.

FIG. 6 is an alternate method for cleaning substrate surfaces in an LCD or IC fabrication process. The method begins at Step 600. Step 602 performs a first organic stripping process on the substrate surface. Step 604 performs a second organic stripping process on the substrate surface. Step 606 performs a third organic stripping process on the substrate surface. Step 608 cleans the substrate surface with high concentrate ozonated water. Step 610 rinses the substrate surface with deionized (DI) water. Step 612 dries the substrate surface.

Cleaning the substrate surface with high concentrate ozonated water in Step 608 includes using water with an ozone concentration of 90 parts per million (PPM), or greater. Further, the high concentrate ozone water cleaning is performed using water having a temperature in the range of 5 to 10 degrees C., with a rinse period of approximately 30 seconds.

A system and method have been provided for cleaning substrates using a high concentrate ozonated water. General procedures were provided for use in cleaning photoresist. Other variations and embodiments will occur to those skilled in the art to modify the invention for specific applications. A chilled water technique of increasing the ozone concentration has been mentioned, however, the present invention cleaning process is effective regardless of the means used to increase the ozone concentration.

We claim:

1. In liquid crystal display (LCD) fabrication, a method for cleaning substrate surfaces comprising:
cleaning a substrate surface with an organic stripper; and,
following the organic stripper cleaning, cleaning the substrate surface with high concentrate ozonated water.

2. The method of claim 1 wherein cleaning the substrate surface with high concentrate ozonated water includes cleaning the substrate surface with water having an ozone concentration of 90 parts per million (PPM), or greater.

3. The method of claim 1 wherein cleaning the substrate surface with high concentrate ozonated water includes cleaning the substrate surface with ozonated water having a water temperature in the range of 5 to 10 degrees C.

4. The method of claim 1 further wherein cleaning the substrate surface with high concentrate ozonated water includes cleaning the substrate surface in ozonated water for a period of approximately 30 seconds.

5. The method of claim 1 further comprising:
following the cleaning of the substrate surface with high concentrate ozonated water, rinsing the substrate surface in deionized (DI) water.

6. In liquid crystal display (LCD) fabrication, a method for cleaning substrate surfaces comprising:
cleaning a substrate surface with an organic stripper;
following the organic stripper cleaning, cleaning the substrate surface with high concentrate ozonated water; and,
following the cleaning of the substrate surface with high concentrate ozonated water, rinsing the substrate surface in deionized (DI) water.

7. The method of claim 6 wherein cleaning the substrate surface with high concentrate ozonated water includes using water with an ozone concentration of 90 parts per million (PPM), or greater.

8. The method of claim 6 wherein cleaning the substrate surface with high concentrate ozonated water includes using water having a temperature in the range of 5 to 10 degrees C.

9. In liquid crystal display (LCD) fabrication, a method for cleaning substrate surfaces comprising:
performing a first organic stripping process on the substrate surface;
performing a second organic stripping process on the substrate surface;
performing a third organic stripping process on the substrate surface;
cleaning the substrate surface with high concentrate ozonated water;
rinsing the substrate surface with deionized (DI) water; and,
drying the substrate surface.

10. The method of claim 9 wherein cleaning the substrate surface with high concentrate ozonated water includes using water with an ozone concentration of 90 parts per million (PPM), or greater.

11. The method of claim 9 wherein cleaning the substrate surface with high concentrate ozonated water includes using water having a temperature in the range of 5 to 10 degrees C.

12. The method of claim 9 wherein cleaning the substrate surface with high concentrate ozonated water includes rinsing the substrate surface in ozonated water for approximately 30 seconds.

13. A system for cleaning liquid crystal display (LCD) substrate surfaces, the system comprising:
at least one organic strip rinse unit having an input to accept a substrate surface and an output to supply the substrate surface following a rinse with an organic stripper; and,
a high concentrate ozonated water rinse unit having an input connected to the organic strip rinse unit output, the high concentrate ozonated water rinse unit having an output to supply the substrate surface following a rinse with ozonated water.

14. The system of claim 13 wherein the high concentrate ozonated water rinse unit rinses the substrate surface with water having an ozone concentration of 90 parts per million (PPM), or greater.

15. The system of claim 13 wherein the high concentrate ozonated water rinse unit rinses the substrate surface with ozonated water having a temperature in the range of 5 to 10 degrees C.

16. The system of claim 13 wherein the high concentrate ozonated water rinse unit rinses the substrate surface in ozonated water for a period of approximately 30 seconds.

17. The system of claim 13 further comprising:
a deionized (DI) water rinse unit having an input connected to the ozonated water rinse unit output, the DI water rinse unit having an output to supply the substrate surface following a rinse in deionized water.

18. The system of claim 17 further comprising:
a dryer unit having an input connected to the output of the DI water rinse unit, the drier unit supplying the substrate surface at an output following the drying of the substrate surface.

19. The system of claim 18 wherein the at least one organic strip rinse unit includes:
a first organic strip rinse unit having an input to accept a substrate surface and an output to supply the substrate surface following a first rinse with an organic stripper;
a second organic strip rinse unit having an input connected to the first organic strip rinse unit output and an output to supply the substrate surface following a second rinse with an organic stripper; and,
a third organic strip rinse unit having an input connected to the second organic strip rinse unit output and an output connected to the ozonated water rinse unit input to supply the substrate surface following a third rinse with an organic stripper.

20. A system for cleaning liquid crystal display (LCD) substrate surfaces, the system comprising:
a first organic strip rinse unit having an input to accept a substrate surface and an output to supply the substrate surface following a first rinse with an organic stripper;
a second organic strip rinse unit having an input connected to the first organic strip rinse unit output and an output to supply the substrate surface following a second rinse with an organic stripper;
a third organic strip rinse unit having an input connected to the second organic strip rinse unit output and an output to supply the substrate surface following a third rinse with an organic stripper;
a high concentrate ozonated water rinse unit having an input connected to the third organic strip rinse unit output, the ozonated water rinse unit having an output to supply the substrate surface following a rinse with ozonated water;
a deionized (DI) water rinse unit having an input connected to the high concentrate ozonated water rinse unit output, the DI water rinse unit having an output to supply the substrate surface following a rinse in deionized water; and,
a dryer unit having an input connected to the output of the DI water rinse unit, the DI rinse unit supplying the substrate surface at an output following the drying of the substrate surface.

21. The system of claim 20 wherein the high concentrate ozonated water rinse unit rinses the substrate surface with water having an ozone concentration of 90 parts per million (PPM), or greater.

22. The system of claim 20 wherein the high concentrate ozonated water rinse unit rinses the substrate surface with ozonated water having a temperature in the range of 5 to 10 degrees C.

23. The system of claim 20 wherein the high concentrate ozonated water rinse unit rinses the substrate surface in ozonated water for a period of approximately 30 seconds.
